(19) United States
(12) Patent Application Publication
(10) Pub. No.: US 2008/0080435 A1
(43) Pub. Date: Apr. 3, 2008

(54) Methods and apparatus for abstracting the state of an RF network

(75) Inventors: Ajay Malik, San Jose, CA (US); Sujai Hajela, Saratoga, CA (US)

Correspondence Address: INGRASSIA FISHER & LORENZ, P.C., 7150 E. CAMELBACK, STE. 325, SCOTTSDALE, AZ, 85251, US

(73) Assignee: Symbol Technologies, Inc.

(21) Appl. No.: 11/529,981

(22) Filed: Sep. 29, 2006

(51) Int. Cl. H04Q 7/24

(52) U.S. Cl. 370/338

(57) ABSTRACT

A system for monitoring the state of an RF network generally includes a plurality of wireless devices coupled to the network and having one or more associated antennae, the wireless devices configured to process data received from a plurality of RF elements within range of the antenna. An RF switch is coupled to the network and configured to receive and transmit the data over the network, the RF switch having a memory configured to store a plurality of performance indicators, wherein each of the performance indicators is associated with an operational characteristic of one or more of the plurality of wireless devices. A display is coupled to the network for displaying a visual representation of the plurality of performance indicators.

### TECHNICAL FIELD

The present invention relates generally to radio frequency identification (RFID) systems, wireless local area networks (WLANs), and other such networks incorporating RF elements, and, more particularly, to methods of characterizing the state of an RF network.

### BACKGROUND

Due the size of modern wireless networks, it has become difficult to plan, monitor, manage, and troubleshoot the system as a whole as well as the individual radio frequency (RF) elements. For example, radio frequency identification (RFID) systems have achieved wide popularity in a number of applications, as they provide a cost-effective way to track the location of a large number of assets in real time. In large-scale application such as warehouses, retail spaces, and the like, many RFID tags may exist in the environment. Likewise, multiple RFID readers are typically distributed throughout the space in the form of entryway readers, conveyer-belt readers, mobile readers, etc., and may be linked by network controller switches and the like.

Similarly, there has been a dramatic increase in demand for mobile connectivity solutions utilizing various wireless components and wireless local area networks (WLANs). This generally involves the use of wireless access points that communicate with mobile devices using one or more RF channels (e.g., in accordance with one or more of the IEEE 802.11 standards).

The number of mobile units and associated access ports, as well as the number of RFID readers and associated antennae, can be very large in an enterprise. As the number of components increases, the management and configuration of those components becomes complicated and time-consuming.

In particular, it is often difficult to determine and visualize the “state” of the network—i.e., how well it is performing, whether the load is balanced, whether coverage is suitable, whether there are any intruders, etc.

Accordingly, it is desirable to provide methods and apparatus for determining and visualizing the state of an RF network incorporating, for example, RFID and WLAN systems. Furthermore, other desirable features and characteristics of the present invention will become apparent from the subsequent detailed description and the appended claims, taken in conjunction with the accompanying drawings and the foregoing technical field and background.

### BRIEF SUMMARY

A system for monitoring the state of an RF network generally includes: a plurality of wireless devices coupled to the network and having one or more associated antennae, the wireless devices configured to process data received from a plurality of RF elements within range of the antennae; an RF switch coupled to the network and configured to receive the data and transmit the data over the network, the RF switch having a memory configured to store a plurality of performance indicators, wherein each of the performance indicators is associated with an operational characteristic of one or more of the plurality of wireless devices; and a display coupled to the network for displaying a visual representation of the plurality of performance indicators.

### BRIEF DESCRIPTION OF THE DRAWINGS

A more complete understanding of the present invention may be derived by referring to the detailed description and claims when considered in conjunction with the following figures, wherein like reference numbers refer to similar elements throughout the figures.

FIG. 1 is a conceptual overview of a system in accordance with an exemplary embodiment of the present invention;

FIG. 2 is a conceptual diagram of a RF switch having a memory and various performance indicators stored therein; and

FIG. 3 is an exemplary bar graph useful in providing a visual representation of the performance indicators.

### DETAILED DESCRIPTION

The following detailed description is merely illustrative in nature and is not intended to limit the invention or the application and uses of the invention. Furthermore, there is no intention to be bound by any express or implied theory presented in the preceding technical field, background, brief summary or the following detailed description.

The invention may be described herein in terms of functional and/or logical block components and various processing steps. It should be appreciated that such block components may be realized by any number of hardware, software, and/or firmware components configured to perform the specified functions. For example, an embodiment of the invention may employ various integrated circuit components, e.g., radio-frequency (RF) devices, memory elements, digital signal processing elements, logic elements, lookup tables, or the like, which may carry out a variety of functions under the control of one or more microprocessors or other control devices. In addition, those skilled in the art will appreciate that the present invention may be practiced in conjunction with any number of data transmission protocols and that the system described herein is merely one exemplary application for the invention.

For the sake of brevity, conventional techniques related to signal processing, data transmission, signaling, network control, the 802.11 family of specifications, wireless networks, RFID systems and specifications, and other functional aspects of the system (and the individual operating components of the system) may not be described in detail herein. Furthermore, the connecting lines shown in the various figures contained herein are intended to represent example functional relationships and/or physical couplings between the various elements. Many alternative or additional functional relationships or physical connections may be present in a practical embodiment.

Without loss of generality, in the illustrated embodiment, many of the functions usually provided by a traditional access point (e.g., network management, wireless configuration, etc.) and/or traditional RFID readers (e.g., data collection, RFID processing, etc.) are concentrated in a corresponding RF switch. It will be appreciated that the present invention is not so limited, and that the methods and systems described herein may be used in conjunction with traditional access points and RFID readers or any other device that communicates via RF channels.

The present invention relates a method of determining and visualizing the state of a RF network using a set of key performance indicators (“performance indicators,” or simply KPI).

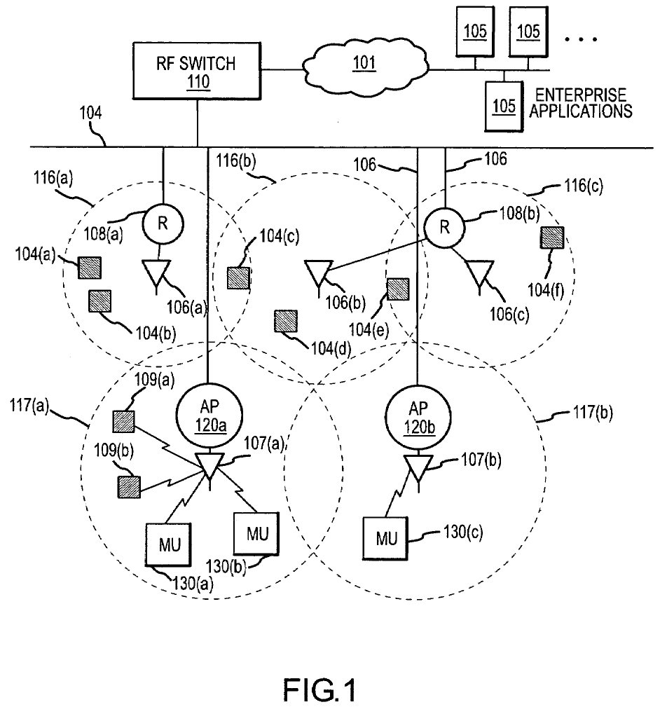

Referring to FIG. 1, in an example system useful in describing the present invention, a switching device 110 (alternatively referred to as an “RF switch,” “WS,” or simply “switch”) is coupled to a network 101 and 104 (e.g., an Ethernet network coupled to one or more other networks or devices) which communicates with one or more enterprise applications 105. One or more wireless access ports 120 (alternatively referred to as “access ports” or “APs”) are configured to wirelessly connect to one or more mobile units 130 (or “MUs”). APs 120 suitably communicate with switch 110 via appropriate communication lines 106 (e.g., conventional Ethernet lines, or the like). Any number of additional and/or intervening switches, routers, servers and other network components may also be present in the system.

A number of RFID tags (or simply “tags”) 104, 107 are distributed throughout the environment. These tags are read by a number of RFID readers (or simply “readers”) 108 having one or more associated antennas 106 provided within the environment. The term “tag” refers, in general, to any RF element that can be communicated with and has an ID that can be read by another component. Readers 108, each of which may be stationary or mobile, are suitably connective via wired or wireless data links to a RF switch 110.

A particular AP 120 may have a number of associated MUs 130. For example, in the illustrated topology, MUs 130(a) and 130(b) are associated with AP 120(a), while MU 130(c) is associated with AP 120(b). One or more APs 120 may be coupled to a single switch 110, as illustrated.

RF Switch 110 determines the destination of packets it receives over network 104 and 101 and routes those packets to the appropriate AP 120 if the destination is an MU 130 with which the AP is associated. Each WS 110 therefore maintains a routing list of MUs 130 and their associated APs 130. These lists are generated using a suitable packet handling process as is known in the art. Thus, each AP 120 acts primarily as a conduit, sending/receiving RF transmissions via MUs 130, and sending/receiving packets via a network protocol with WS 110. AP 120 is typically capable of communicating with one or more MUs 130 through multiple RF channels. This distribution of channels varies greatly by device, as well as country of operation. For example, in one U.S. embodiment (in accordance with 802.11(b)) there are fourteen overlapping, staggered channels, each centered 5 MHz apart in the RF band.

A particular RFID reader 108 may have multiple associated antennas 106. For example, as shown in FIG. 1, reader 108(a) is coupled to one antenna 106(a), and reader 108(b) is coupled to two antennas 106(b) and 106(c). Reader 108 may incorporate additional functionality, such as filtering, cyclic-redundancy checks (CRC), and tag writing, as is known in the art.

In general, RFID tags (sometimes referred to as “transponders”) may be classified as either active, passive, or semi-active. Active tags are devices that incorporate some form of power source (e.g., batteries, capacitors, or the like) and are typically always “on,” while passive tags are tags that are exclusively energized via an RF energy source received from a nearby antenna. Semi-active tags are tags with their own power source, but which are in a standby or inactive mode until they receive a signal from an external RFID reader, whereupon they “wake up” and operate for a time just as though they were active tags. While active tags are more powerful, and exhibit a greater range than passive tags, they also have a shorter lifetime and are significantly more expensive. Such tags are well known in the art, and need not be described in detail herein.

Each antenna 106 has an associated RF range (or “read point”) 116, which depends upon, among other things, the strength of the respective antenna 106. The read point 116 corresponds to the area around the antenna in which a tag 104 may be read by that antenna, and may be defined by a variety of shapes, depending upon the nature of the antenna (i.e., the RF range need not be circular or spherical as illustrated in FIG. 1). An antenna 107 coupled to an AP 120 may also communicate directly with RFID tags (such as tags 109(a) and 109(b), as illustrated).

It is not uncommon for RF ranges or read points to overlap in real-world applications (e.g., doorways, small rooms, etc.). Thus, as shown in FIG. 1, read point 116(a) overlaps with read point 116(b), which itself overlaps with read point 116(c). Accordingly, it is possible for a tag to exist within the range of two or more readers simultaneously. For example, tag 104(c) falls within read points 116(a) and 116(b), and tag 104(f) falls within read points 116(b) and 116(c). Because of this, two readers (108(a) and 108(b)) may sense the presence of (or other event associated with) tag 104(c).

As described in further detail below, switch 102 includes hardware, software, and/or firmware capable of carrying out the functions described herein. Thus, switch 102 may comprise one or more processors accompanied by storage units, displays, input/output devices, an operating system, database management software, networking software, and the like. Such systems are well known in the art, and need not be described in detail. Switch 102 may be configured as a general purpose computer, a network switch, or any other such network host. In a preferred embodiment, controller 102 is modeled on a network switch architecture but includes RF network controller software (or “module”) whose capabilities include, among other things, the ability to allow configure and monitor readers 108 and antennas 106.

RF switch 110 allows multiple read points 116 to be logically combined, via controller 102, within a single read point zone (or simply “zone”). For example, referring to FIG. 1, a read point zone 120 may be defined by the logical union of read points 116(a), 116(b), and 116(c). Note that the read points need not overlap in physical space, and that disjoint read points (e.g., read point 116(d)) may also be included in the read point zone if desired. In a preferred embodiment, antennas (i.e., read points defined by the antennas) can be arbitrarily assigned to zones, regardless of whether they are associated with the same reader. That is, referring to FIG. 1, antennas 106(b) and 106(c), while both associated with reader 108(b), may be part of different zones. Controller 102 then receives all tag data from readers 108 via respective data links 103 (e.g., wired communication links, 802.11 connections, or the like), then aggregates and filters this data based on zone information. The read point zones are suitably preconfigured by a user or administrator. That is, the user is allowed to access controller 110 and, through a configuration mode, specify a set of read points that are to be included in a particular zone. RF switch 110. includes a cell controller (CC) and an RFID network controller (RNC), In general, the RNC includes hardware and software configured to handle RFID data communication and administration of the RFID network components, while the CC includes hardware and software configured to handle wireless data (e.g., in accordance with IEEE 802.11) from the mobile units and access ports within wireless cells. In one embodiment, RF switch 110 includes a single unit with an enclosure containing the various hardware and software components necessary to perform the various functions of the CC and RNC as well as suitable input/output hardware interfaces to networks 101 and 104.

As mentioned above, the present invention relates a method of determining and visualizing the state of a RF network (such as that shown in FIG. 1) using a set of key performance indicators (“performance indicators,” or simply KPI). Each of the performance indicators, as detailed below, is associated with an operational characteristic of one or more of the wireless devices communicating on the network.

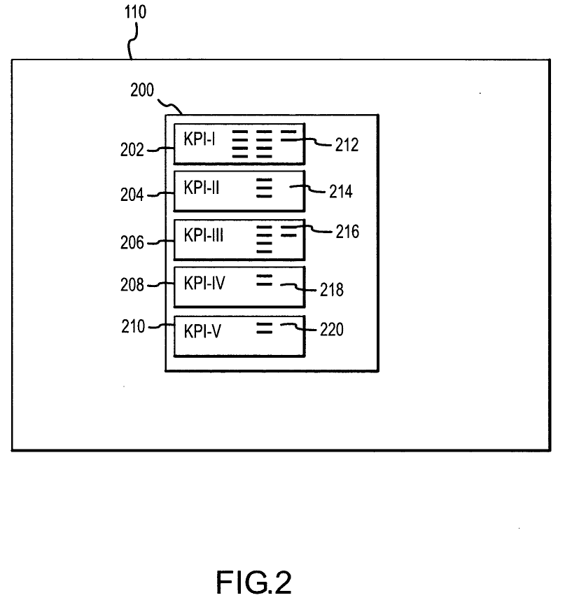

In a particular embodiment, five performance indicators are defined as a factory default: KPI-I through KPI-V. This is illustrated conceptually in FIG. 2, wherein RF switch is shown with a memory 200 (i.e., any form of conventional storage) used to store five performance indicators 202, 204, 206, 208, and 210. These performance indicators may alternatively be stored elsewhere in the network, or distributed over multiple servers or hosts. The user is allowed to create his own set of key performance indicators. That is, he is provided with a set of variables and mathematical formulae that the user may select from, allowing him to monitor the RF network in the way the user prefers.

In the illustrated embodiment, the first performance indicator 202 (KPI-I) is a metric associated with RF coverage. In one embodiment KPI-I includes a set of numbers 212 associated with RF coverage in the RF network (KPI-I(a)-(i)). That is, KPI-I is computed from this set of numbers, wherein the numbers relate to measured characteristics of the network or the components disposed therein. In one embodiment, KPI-I(a) is equal to the number of system components that are operational and/or configured—i.e., 802.11 APs, 802.11 radios, RFID readers, RFID antennas, WiMAX APs, and WiMax Radios, and any other components as may be appropriate. KPI-I(b) is equal to the number of system components with operational and/or configured channels. KPI-I(c) is associated with the number of system components with operational and/or configured power. KPI-I(d) is equal to the number of operational and/or configured data rates. KPI-I(e) is equal to the number of MUs transfer at maximum bit speed, number of tags seen, channel health as seen per tag read, etc. KPI-I(f) is equal to the number of switch level retries and collision count per bucket. KPI-I(g) is equal to switch level average 802.11 RSSI per bucket/channel health per tag read. KPI-I(h) is equal to the average bit speed and how close it is to the maximum rate possible for the various MUs. KPI-I(i) is equal to the average 802.11 bit speed/RFID tag read rate/collision rate as per predicted and/or current heat map of the facility in which the components are deployed. It will be appreciated that these specific metrics for KPI-I(a)-(i).

The second performance indicator 204 (KPI-II) is a metric associated with load balancing in the RF network. In a specific embodiment, KPI-II includes a set of three numbers 214, KPI-II(a)-(c), where KPI-II(a) is associated with the balancing of APs across switches, KPI-II(b) is associated with the balancing of MUs across switches, and KPI-II(c) is associated with the number of MUs balanced across APs. This enables the user to add changes in the network to provide better RF coverage as load increases.

The third performance indicator 206 (KPI-III) is a metric associated with security threat level. In a specific embodiment, KPI-III includes a set of six numbers 216, KPI-III(a)-(f), where KPI-III(a) is associated with the number of rogue APs and/or RFID readers or RF devices managed by the RF switch, KPI-III(b) is associated with the number of IDS events (sniffer attacks, denial-of-service attacks, etc.), KPI-III(c) is associated with the amount of RF slippage currently and/or planned, KPI-III(d) is associated with the location of one or more intruders, KPI-III(e) is associated with the number of users connected to the network, and KPI-III(f) is associated with the number of incorrect password requests. This allow the user to determine whether some action must be taken to secure the network.

The fourth performance indicator 208 (KPI-IV) is a metric associated with redundancy (i.e., a redundancy quotient, or resiliency quotient). In a specific embodiment, KPI-IV includes a set of two numbers 218: KPI-IV(a), which is associated with the status of members of a particular cluster within the network (e.g., how many are reachable, how many are standbys), and KPI-IV(b), which is associated with the self-healing status of the radios, RFID antennas, WiMax radios, etc. This enables the user to determine whether the network has enough “resiliency” to tolerate failures, and what the thresholds for action should be.

The fifth performance indicator 210 (KPI-V) is a metric associated with network utilization. In a specific embodiment, KPI-V includes a set of two numbers 220: KPI-V(a), which is associated with the number of switches, the capacity of the switches, and the current usage; and KPI-V(b), which is associated with the number, capacity, and current usage of radios and/or antennae.

The values of the performance indicators may be integers, real numbers, or any suitable numeric value. The performance indicators may be normalized (e.g., to a number between 0-100, or 0.0-1.0), or may an unbounded numeric value. Each performance indicator is a suitable function of the set of numbers it comprises. For example, KPI-II comprises three numbers, each related to the number of components that are balanced among other components of the system. In each case, the balancing may be assigned a number ranging from zero (not balanced) and 100 (fully balanced). A weighting function or linear equation may then be applied to each of these three numbers to produce a given numeric value of KPI-II, which itself ranges between 0 and 100. The selection of functions for each of the performance indicators may be selected in accordance with known principles and to achieve any particular design goal.

In accordance with another aspect of the present invention, the various KPI values are presented in visual form for review by an administrator, user, or other operator of the system. This visual representation may be produced on any convenient display that can access RF switch 110 of the network—e.g., via a browser accessing a webpage produced using the data residing within memory 200.

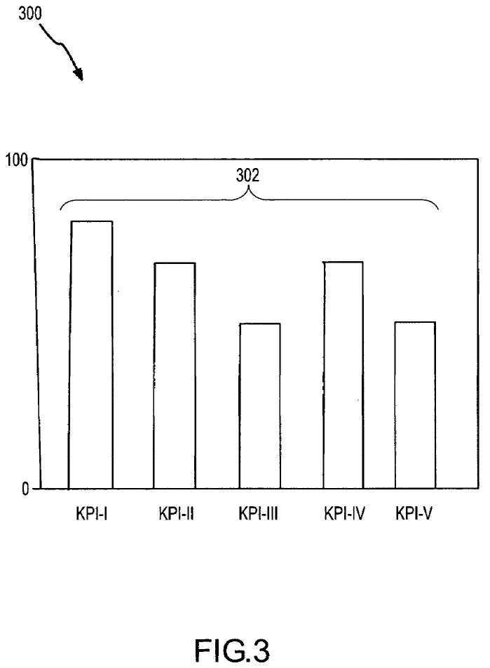

Referring to FIG. 3, for example, the display might be in the nature of a bar graph 300. As shown, the vertical axis ranges from zero to 100, where zero corresponds to an undesirable value, and 100 corresponds to a desirable value. The horizontal axis presents the five performance indictors KPI-I through KPI-V, wherein a series of bars 302 are associated with each of the performance indicators. It will be appreciated that other visual representations of this data may be used, including, for example, line graphs, scatter plots, pie-charts, and the like. Further more, graph 300 may be static, or may change in real time as the values of the performance indicators change. In other embodiments, individual numeric values for each of the performance indicators are displayed.

In yet another embodiment, the system may be configured such that a suitable alarm is produced and communicated to a user when a particular state of the performance indicators occurs—e.g., if a particular performance indicator drops below a certain level, or if the combination of multiple performance indicators drops achieves a particular value or range of values. The administrator may be allowed to set up any arbitrary rules for generating such alarms.

It should be appreciated that the example embodiment or embodiments described herein are not intended to limit the scope, applicability, or configuration of the invention in any way. Rather, the foregoing detailed description will provide those skilled in the art with a convenient road map for implementing the described embodiment or embodiments. It should be understood that various changes can be made in the function and arrangement of elements without departing from the scope of the invention as set forth in the appended claims and the legal equivalents thereof.

What is claimed is:

1. A system for monitoring the state of an RF network, the system comprising:
a plurality of wireless devices coupled to the network and having one or more associated antennae, the wireless devices configured to process data received from a plurality of RF elements within range of the antennae;
an RF switch coupled to the network and configured to receive the data and transmit the data over the network, the RF switch having a memory configured to store a plurality of performance indicators, wherein each of the performance indicators is associated with an operational characteristic of one or more of the plurality of wireless devices; and
a display coupled to the network for displaying a visual representation of the plurality of performance indicators.

2. The system of claim 1, wherein the visual representation comprises a bar graph comprising a number of bars, each of which is associated with a respective performance indicator.

3. The system of claim 1, wherein each of the performance indicators are computed from a set of numbers corresponding to measured characteristics of the network.

4. The system of claim 3, wherein each of the performance indicators are normalized values having a minimum and a maximum value.

5. The system of claim 4, wherein the maximum and minimum values are the same for each of the performance indicators.

6. The system of claim 5, wherein the performance indicators include a performance indicator associated with RF coverage of the network.

7. The system of claim 5, wherein the performance indicators include a performance indicator associated with load balancing of the network.

8. The system of claim 5, wherein the performance indicators include a performance indicator associated with security threat level.

9. The system of claim 5, wherein the performance indicators include a performance indicator associated with a redundancy quotient of the network.

10. The system of claim 5, wherein the performance indicators include a performance indicator associated with network utilization.

11. A method for monitoring the state of an RF network, the method comprising:
providing a plurality of wireless devices coupled to the network and having one or more associated antennae, the wireless devices configured to process data received from a plurality of RF elements within range of the antennae;
determining a plurality of performance indicators, wherein each of the performance indicators is associated with an operational characteristic of one or more of the plurality of wireless devices;
storing the plurality of performance indicators; and
displaying a visual representation of the plurality of performance indicators.

12. The method of claim 11, wherein displaying the visual representation comprises displaying a bar graph comprising a number of bars, each of which is associated with a respective performance indicator, and wherein each of the performance indicators is normalized between a maximum and minimum value.

13. The method of claim 11, wherein the performance indicators include a performance indicator associated with RF coverage of the network.

14. The method of claim 11, wherein the performance indicators include a performance indicator associated with load balancing of the network.

15. The method of claim 11, wherein the performance indicators include a performance indicator associated with security threat level.

16. The method of claim 11, wherein the performance indicators include a performance indicator associated with a redundancy quotient of the network.

17. The method of claim 11, wherein the performance indicators include a performance indicator associated with network utilization.

18. The method of claim 11, further including storing the performance indicators in a memory provided within an RF switch coupled to the plurality of wireless devices.
